(19) United States
(12) Patent Application Publication
(10) Pub. No.: US 2016/0232537 A1
(43) Pub. Date: Aug. 11, 2016

(54) STATISTICALLY AND ONTOLOGICALLY CORRELATED ANALYTICS FOR BUSINESS INTELLIGENCE

(71) Applicant: International Business Machines Corporation, Armonk, NY (US)

(72) Inventors: Robert Y. Nonez, Orleans (CA); Angela B. Shen-Hsieh, Cambridge, MA (US)

(21) Appl. No.: 14/619,786

(22) Filed: Feb. 11, 2015

(51) Int. Cl. G06Q 30/02; G06F 17/30

(52) U.S. Cl. CPC G06Q 30/0201; G06F 17/30404; G06F 17/3053; G06F 17/30554

(57) ABSTRACT

Techniques are disclosed for statistically and ontologically correlated business intelligence (BI) analytics. An example method includes performing an ontological analysis on relevant data defined for a BI analytics query to determine correlations with ontological concepts. The method includes performing a statistical analysis on direct analytics output data to rank the direct analytics output data in order of influence on the direct analytics output. The method includes performing a statistical analysis on the relevant data set relative to the direct analytics output data to determine data in the relevant data set that influence the direct analytics output data, thereby generating a list of key drivers ranked in order of influence. The method includes revising the ranking of the key drivers based on correlations of the key drivers with the ontological concepts. The method includes generating a correlated analytics output comprising information on the key drivers based on the ranking.

### TECHNICAL FIELD

This disclosure relates to business intelligence (BI) systems, and more particularly, to BI analytics systems.

### BACKGROUND

Enterprise software systems are typically sophisticated, large-scale systems that support many, e.g., hundreds or thousands, of concurrent users. Examples of enterprise software systems include financial planning systems, budget planning systems, order management systems, inventory management systems, sales force management systems, business intelligence tools, enterprise reporting tools, project and resource management systems, and other enterprise software systems.

Many enterprise performance management and business planning applications require a large base of users to enter data that the software then accumulates into higher level areas of responsibility in the organization. Moreover, once data has been entered, it must be retrieved to be utilized. The system may perform mathematical calculations on the data, combining data submitted by many users. Using the results of these calculations, the system may generate reports for review by higher management. Often these complex systems make use of multidimensional data sources that organize and manipulate the tremendous volume of data using data structures referred to as data cubes. Each data cube, for example, includes a plurality of hierarchical dimensions having levels and members for storing the multidimensional data.

Business intelligence (BI) systems may be used to provide insights into such collections of enterprise data. In some cases, a BI analytics system may perform analysis on data in response to user queries, and present BI analytics data responsive to the queries.

### SUMMARY

In general, examples are disclosed herein directed to techniques, methods, systems, devices, and computer program products for statistically and ontologically correlated analytics in a business intelligence (BI) analytics system. A statistically and ontologically correlated analytics system of this disclosure may perform and present results from statistically and ontologically correlated analysis of data related to a user-initiated business intelligence (BI) analytics query. These results, which may also be referred to as “orthogonal insights,” may go beyond the typical results of directly processing a query. In statistically and ontologically correlated analytics of this disclosure, a BI system searches data indirectly related to a user-initiated BI analytics query and performs statistical and ontological analyses of the indirectly related data and its context to determine a particularly relevant subset of the indirectly related data to present to the user together with the direct results of the query. The statistically and ontologically correlated analytics system may thereby provide to the user information that goes beyond what the user was explicitly looking for but that may still be directly relevant to the user's goals and interests, and that may sometimes even serendipitously include information the user finds valuable but didn't yet know to look for.

A statistically and ontologically correlated analytics system of this disclosure may implement or access statistical and ontological analyses of the indirectly related data processed via statistical and ontological analysis subsystems, as part of determining a particularly correlated subset of the indirectly related data. A statistically and ontologically correlated analytics system of this disclosure may provide the user with the most relevant results the user had not yet searched for or not yet thought to search for, and may thus broaden or accelerate the usefulness of a BI analytics system.

In one example, a method for business intelligence (BI) analytics includes performing, by one or more processing devices, an ontological analysis on data items in a relevant data set defined for a BI analytics query to determine one or more correlations of the data items in the relevant data set with ontological concepts in an ontological concept subsystem. The method further includes performing, by the one or more processing devices, a first statistical analysis on a set of direct analytics output data items from the relevant data set that are included in a direct BI analytics output to rank the direct analytics output data items in an order of influence on the direct BI analytics output. The method further includes performing, by the one or more processing devices, a second statistical analysis on the data items in the relevant data set relative to the direct analytics output data items to determine one or more of the data items in the relevant data set that influence the respective direct analytics output data items, thereby generating a list of key drivers from among the data items in the relevant data set such that the list of key drivers has a ranking in an order of the influence. The method further includes revising, by the one or more processing devices, the ranking of the list of key drivers based at least in part on the correlations of the key drivers with the ontological concepts. The method further includes generating, by the one or more processing devices, a correlated analytics output comprising information on one or more of the key drivers based on the ranking of the list of key drivers.

In another example, a computer program product for business intelligence (BI) analytics includes a computer-readable storage medium having program code embodied therewith. The program code is executable by a computing device to perform an ontological analysis on data items in a relevant data set defined for a BI analytics query to determine one or more correlations of the data items in the relevant data set with ontological concepts in an ontological concept subsystem. The program code is further executable by a computing device to perform a first statistical analysis on a set of direct analytics output data items from the relevant data set that are included in a direct BI analytics output to rank the direct analytics output data items in an order of influence on the direct BI analytics output. The program code is further executable by a computing device to perform a second statistical analysis on the data items in the relevant data set relative to the direct analytics output data items to determine one or more of the data items in the relevant data set that influence the respective direct analytics output data items, thereby generating a list of key drivers from among the data items in the relevant data set such that the list of key drivers has a ranking in an order of the influence. The program code is further executable by a computing device to revise the ranking of the list of key drivers based at least in part on the correlations of the key drivers with the ontological concepts. The program code is further executable by a computing device to generate a correlated analytics output comprising information on one or more of the key drivers based on the ranking of the list of key drivers.

In another example, a computer system for business intelligence (BI) analytics includes one or more processors, one or more computer-readable memories, and one or more computer-readable, tangible storage devices. The computer system further includes program instructions, stored on at least one of the one or more storage devices for execution by at least one of the one or more processors via at least one of the one or more memories, to perform an ontological analysis on data items in a relevant data set defined for a BI analytics query to determine one or more correlations of the data items in the relevant data set with ontological concepts in an ontological concept subsystem. The computer system further includes program instructions, stored on at least one of the one or more storage devices for execution by at least one of the one or more processors via at least one of the one or more memories, to perform a first statistical analysis on a set of direct analytics output data items from the relevant data set that are included in a direct BI analytics output to rank the direct analytics output data items in an order of influence on the direct BI analytics output. The computer system further includes program instructions, stored on at least one of the one or more storage devices for execution by at least one of the one or more processors via at least one of the one or more memories, to perform a second statistical analysis on the data items in the relevant data set relative to the direct analytics output data items to determine one or more of the data items in the relevant data set that influence the respective direct analytics output data items, thereby generating a list of key drivers from among the data items in the relevant data set such that the list of key drivers has a ranking in an order of the influence. The computer system further includes program instructions, stored on at least one of the one or more storage devices for execution by at least one of the one or more processors via at least one of the one or more memories, to revise the ranking of the list of key drivers based at least in part on the correlations of the key drivers with the ontological concepts. The computer system further includes program instructions, stored on at least one of the one or more storage devices for execution by at least one of the one or more processors via at least one of the one or more memories, to generate a correlated analytics output comprising information on one or more of the key drivers based on the ranking of the list of key drivers.

The details of one or more embodiments of the disclosure are set forth in the accompanying drawings and the description below. Other features, objects, and advantages of the invention will be apparent from the description and drawings, and from the claims.

### BRIEF DESCRIPTION OF DRAWINGS

FIG. 1 is a conceptual block diagram illustrating an example enterprise having a computing environment in which users interact with an enterprise business intelligence system that includes a statistically and ontologically correlated analytics system.

FIG. 2 is a conceptual block diagram illustrating one embodiment of an enterprise business intelligence computing environment including a BI analytics system including a statistically and ontologically correlated analytics system as part of an enterprise BI computing system.

FIG. 3 shows a conceptual block diagram of a BI analytics system within an enterprise BI system initiating a response to an analytics query by searching for and defining a relevant data set for the analytics query from among data stores, in one example.

FIG. 4 shows a conceptual block diagram of a correlated analytics system performing statistical and ontological analysis on direct analytics output data by a direct analytics system and on a complete relevant data set for an analytics query to generate a statistically and ontologically correlated analytics output, in one example.

FIG. 5 shows an example screenshot of a BI analytics UI application with a direct analytics output as generated by a direct analytics system and a statistically and ontologically correlated analytics output as generated by a correlated analytics system, in response to an analytics query, in one example.

FIG. 6 shows a flowchart for a statistically and ontologically correlated analytics process that a correlated analytics system, executing on one or more computing devices (e.g., application servers, other servers, computers, processors, etc.), may perform, in one example.

FIG. 7 is a block diagram of a computing device that may be used to execute statistically and ontologically correlated analytics program code and to implement a correlated analytics system, in one example.

### DETAILED DESCRIPTION

Various examples are disclosed herein for a statistically and ontologically correlated analytics system. In various examples disclosed herein, a statistically and ontologically correlated analytics system of this disclosure may perform statistical and ontological analysis of a relevant data set to an analytics query and a direct analytics output based on the relevant data set that directly responds to the query, and provide analytics outputs that are statistically and ontologically correlated to the direct results of the query. Examples of illustrative BI system contexts in which a statistically and ontologically correlated analytics system may be implemented are described as follows.

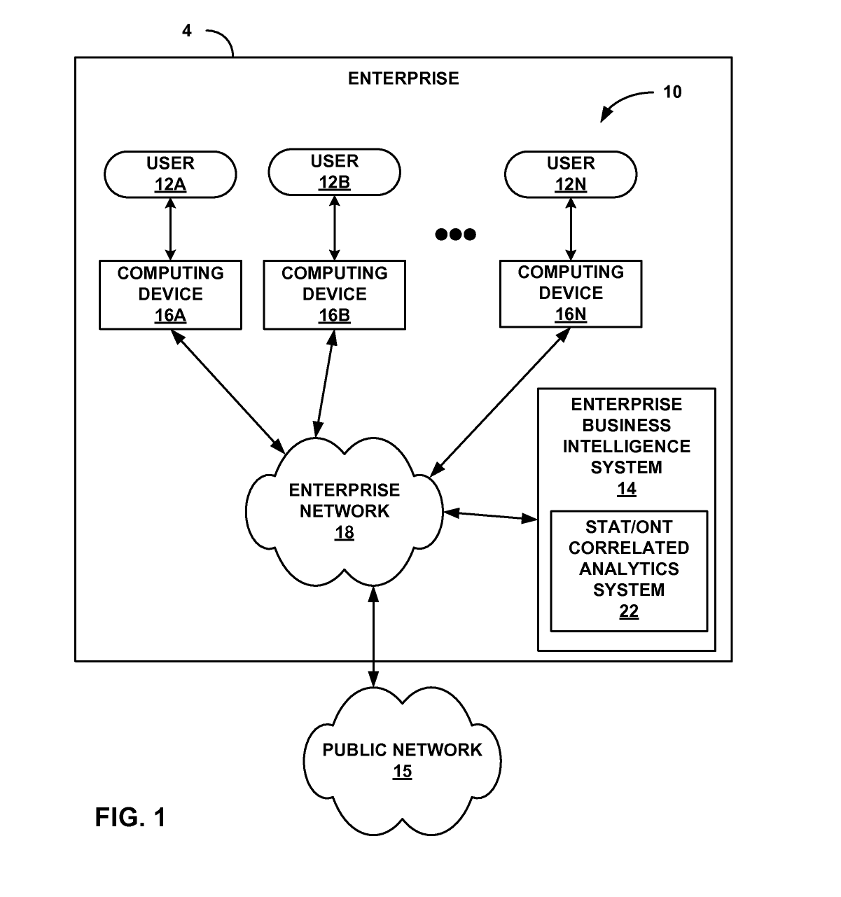

FIG. 1 illustrates an example context in which a system of this disclosure may be used. FIG. 1 is a conceptual block diagram illustrating an example enterprise 4 having a computing environment 10 in which a plurality of users 12A-12N (collectively, “users 12”) may interact with an enterprise business intelligence (BI) system 14 that includes an ontologically and statistically correlated analytics system 22 (“correlated analytics system 22”), as described further below. In the system shown in FIG. 1, enterprise business intelligence system 14 is communicatively coupled to a number of client computing devices 16A-16N (collectively, “client computing devices 16” or “computing devices 16”) by an enterprise network 18. Users 12 interact with their respective computing devices to access enterprise business intelligence system 14. Users 12, computing devices 16A-16N, enterprise network 18, and enterprise business intelligence system 14 may all be either in a single facility or widely dispersed in two or more separate locations anywhere in the world, in different examples.

For exemplary purposes, various examples of the techniques of this disclosure may be readily applied to various software systems, including enterprise business intelligence systems or other large-scale enterprise software systems. Examples of enterprise software systems include enterprise financial or budget planning systems, order management systems, inventory management systems, sales force management systems, business intelligence tools, enterprise reporting tools, project and resource management systems, and other enterprise software systems.

In this example, enterprise BI system 14 includes servers that run BI dashboard web applications and may provide business analytics software. A user 12 may use a BI portal on a client computing device 16 to view and manipulate information such as BI analytics and BI reports and other collections and visualizations of data via a respective computing device 16. This may include data from any of a wide variety of sources, including from multidimensional data structures and relational databases within enterprise 4, as well as data from a variety of external sources that may be accessible over public network 15.

Users 12 may use a variety of different types of computing devices 16 to interact with enterprise business intelligence system 14 and access BI analytics and data visualization tools and other resources via enterprise network 18. For example, an enterprise user 12 may interact with enterprise business intelligence system 14 and run a business intelligence (BI) portal (e.g., a business intelligence dashboard, etc.) using a laptop computer, a desktop computer, or the like, which may run a web browser. Alternatively, an enterprise user may use a smartphone, tablet computer, or similar device, running a business intelligence dashboard in a web browser, a dedicated mobile application, or other means for interacting with enterprise business intelligence system 14.

Enterprise network 18 and public network 15 may represent any communication network, and may include a packet-based digital network such as a private enterprise intranet or a public network like the Internet. In this manner, computing environment 10 can readily scale to suit large enterprises. Enterprise users 12 may directly access enterprise business intelligence system 14 via a local area network, or may remotely access enterprise business intelligence system 14 via a virtual private network, remote dial-up, or similar remote access communication mechanism.

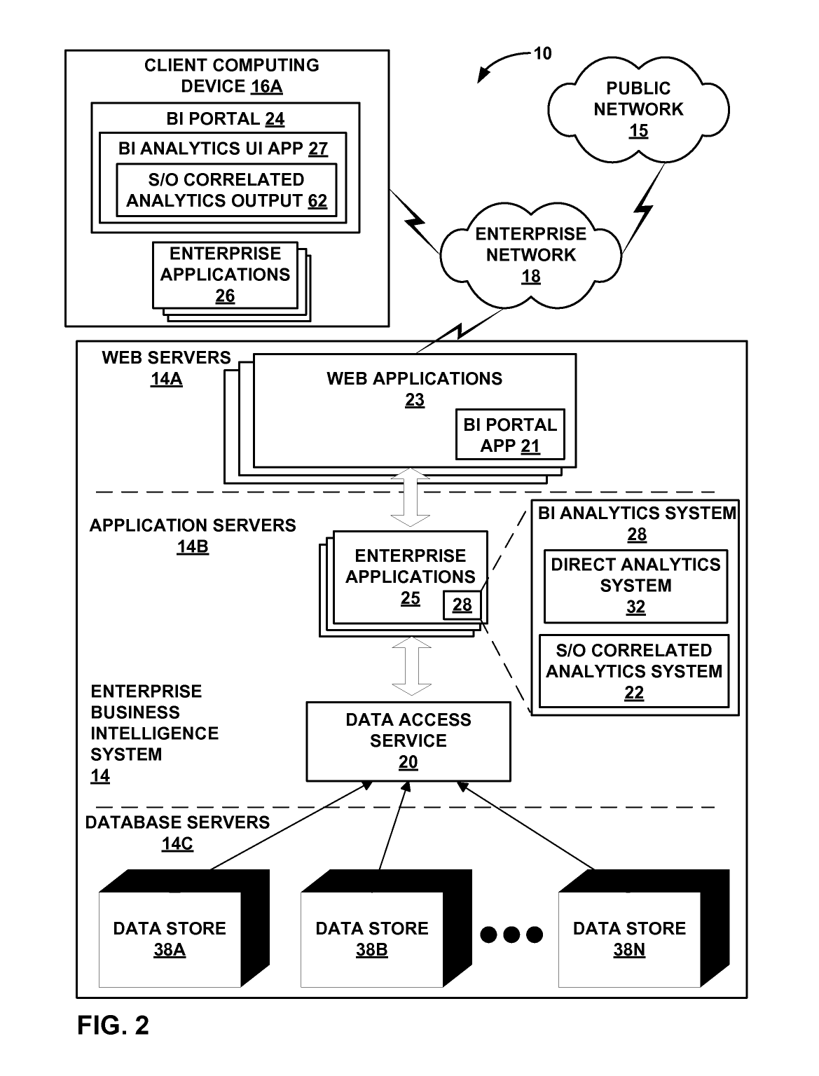

FIG. 2 is a conceptual block diagram illustrating in further detail portions of one embodiment of enterprise business intelligence (BI) computing environment 10 that includes a BI analytics system 28 including statistically and ontologically correlated analytics system 22 as part of an enterprise BI computing system 14. In this example implementation, a single client computing device 16A is shown for purposes of example and includes a BI portal 24 and one or more client-side enterprise software applications 26 that may utilize and manipulate multidimensional data, including to view analytics tools and data visualizations with BI portal 24. BI portal 24 may be rendered within a general web browser application, within a locally hosted application or mobile application, or other user interface. BI portal 24 may be generated or rendered using any combination of application software and data local to the computing device it's being generated on, and/or remotely hosted in one or more application servers or other remote resources. BI portal 24 may include a user interface for a BI analytics user interface (UI) application 27 that may interact with a BI analytics system 28 that comprises a direct analytics system 32 and a statistically and ontologically correlated analytics system 22 (“correlated analytics system 22”). BI analytics UI application 27 may enable a user of client computing device 16A to enter analytics queries, in response to which BI analytics system 28 may generate both direct analytics outputs from the operation of direct analytics system 32 and statistically and ontologically correlated analytics outputs from correlated analytics system 22, as further described below.

BI portal 24 may also output data visualizations for a user to view and manipulate in accordance with various techniques described in further detail below. BI portal 24 may present data in the form of charts or graphs that a user may manipulate, for example. BI portal 24 may present visualizations of data based on data from sources such as a BI report, e.g., that may be generated with enterprise business intelligence system 14, or another BI dashboard, as well as other types of data sourced from external resources through public network 15. BI portal 24 may present visualizations of data based on data that may be sourced from within or external to the enterprise.

Example embodiments of the present disclosure, such as correlated analytics system 22 depicted in FIG. 1, may generate a statistically and ontologically correlated analytics output comprising information on data from a relevant data set that is statistically and ontologically correlated with the direct analytics output. Correlated analytics system 22 may be part of a BI analytics system that responds to BI analytics queries, based on relevant data sets the analytics system defines for the queries. Correlated analytics system 22 may perform both an ontological analysis on the relevant data set for a query, and statistical analyses on both the direct analytics output responsive to a query and the relevant data set, to generate a correlated analytics output that is statistically and ontologically correlated to the direct analytics output responsive to a query, as further described below.

FIG. 2 depicts additional detail for enterprise business intelligence system 14 and how it may be accessed via interaction with a BI portal 24 for depicting and providing visualizations of business data. BI portal 24 may provide visualizations of data that represents, provides data from, or links to any of a variety of types of resource, such as a BI report, a software application, a database, a spreadsheet, a data structure, a flat file, Extensible Markup Language (“XML”) data, a comma separated values (CSV) file, a data stream, unorganized text or data, or other type of file or resource. BI portal 24 may also provide statistically and ontologically correlated analytics outputs generated by correlated analytics system 22, for example.

Correlated analytics system 22 may be hosted among enterprise applications 25, as in the example depicted in FIG. 2, or may be hosted elsewhere, including on a client computing device 16A, or distributed among various computing resources in enterprise business intelligence system 14, in some examples. Correlated analytics system 22 may be implemented as or take the form of a stand-alone application, a portion or add-on of a larger application, a library of application code, a collection of multiple applications and/or portions of applications, or other forms, and may be executed by any one or more servers, client computing devices, processors or processing units, or other types of computing devices.

As depicted in FIG. 2, enterprise business intelligence system 14 is implemented in accordance with a three-tier architecture: (1) one or more web servers 14A that provide web applications 23 with user interface functions, including a server-side BI portal application 21; (2) one or more application servers 14B that provide an operating environment for enterprise software applications 25 and a data access service 20; and (3) database servers 14C that provide one or more data sources 38A, 38B, . . . , 38N (“data sources 38”). Enterprise software applications 25 may include correlated analytics system 22, direct analytics system 32, and/or BI analytics system 28 among enterprise software applications 25 or as a portion or portions of one or more of enterprise software applications 25.

The data sources 38 may include two-dimensional databases and/or multidimensional databases or data cubes. The data sources may be implemented using a variety of vendor platforms, and may be distributed throughout the enterprise. As one example, the data sources 38 may be multidimensional databases configured for Online Analytical Processing (OLAP). As another example, the data sources 38 may be multidimensional databases configured to receive and execute Multidimensional Expression (MDX) queries of some arbitrary level of complexity. As yet another example, the data sources 38 may be two-dimensional relational databases configured to receive and execute SQL queries, also with an arbitrary level of complexity.

Multidimensional data structures are “multidimensional” in that each multidimensional data element is defined by a plurality of different object types, where each object is associated with a different dimension. The enterprise applications 26 on client computing device 16A may issue business queries to enterprise business intelligence system 14 to build reports. Enterprise business intelligence system 14 includes a data access service 20 that provides a logical interface to the data sources 38. Client computing device 16A may transmit query requests through enterprise network 18 to data access service 20. Data access service 20 may, for example, execute on the application servers intermediate to the enterprise software applications 25 and the underlying data sources in database servers 14C. Data access service 20 retrieves a query result set from the underlying data sources, in accordance with query specifications. Data access service 20 may intercept or receive queries, e.g., by way of an API presented to enterprise applications 26. Data access service 20 may then return this result set to enterprise applications 26 as BI reports, other BI objects, and/or other sources of data that are made accessible to BI portal 24 on client computing device 16A. These may include data sets relevant to a BI analytics query in response to a search and definition of relevant data by BI analytics system 28, as further described below.

Example embodiments of the present disclosure, such as correlated analytics system 22 depicted in FIG. 2, may generate a statistically and ontologically correlated analytics output comprising information on data from a relevant data set that is statistically and ontologically correlated with the direct analytics output. As described above and further below, correlated analytics system 22 may be implemented in one or more computing devices, and may involve one or more applications or other software modules that may be executed on one or more processors. Example embodiments of the present disclosure may illustratively be described in terms of the example of correlated analytics system 22 as part of a BI analytics system 28 as shown in various examples described below.

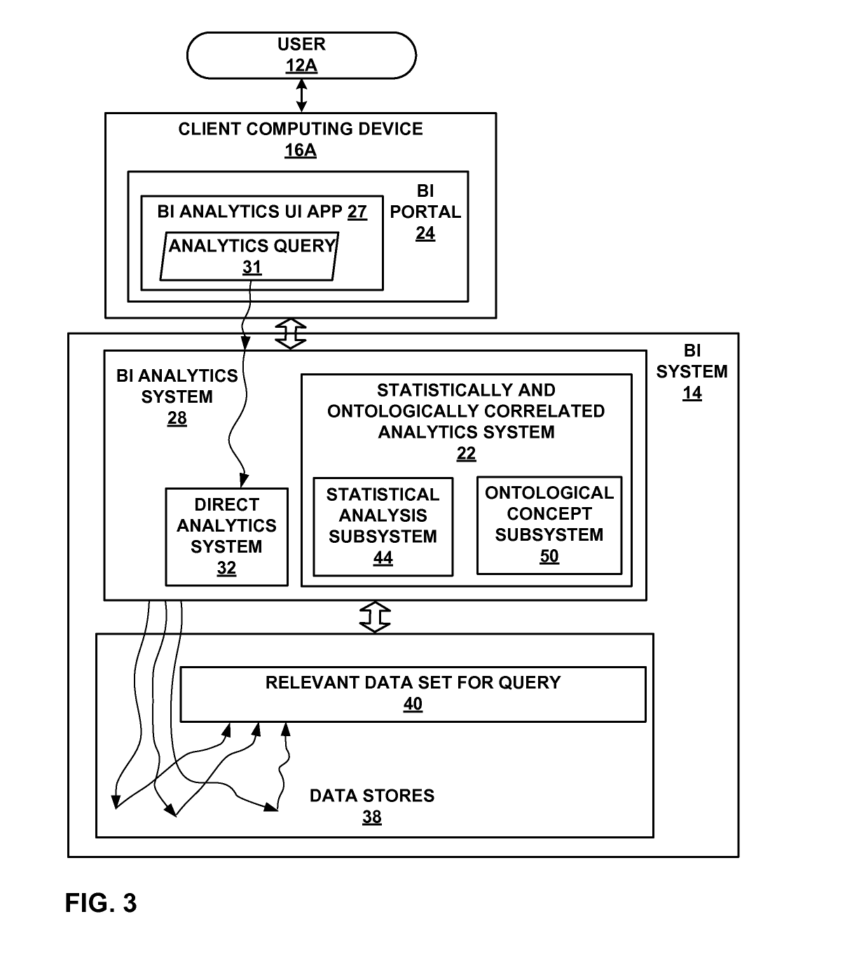

FIG. 3 shows a conceptual block diagram of BI analytics system 28 within enterprise BI system 14 initiating a response to an analytics query 31 by searching for and defining a relevant data set 40 for the analytics query from among data stores 38, in one example. User 12A may interact with BI analytics UI application 27 in BI portal 24 on client computing device 16A to compose the analytics query 31. User 12A may, for example, be a BI report author or analytics specialist preparing BI reports for business management users, and seeking to explore relevant BI analytics data for inclusion in the BI reports. In a typical example of an analytics query 31 processed by BI analytics system 28, user 12A may compose a query for information such as on a selected set of products sold in one or more selected countries over a particular period of time, or market survey scores for a selected product category over a particular period of time, for example.

BI analytics system 28 may initially process that query through direct analytics system 32 and define a relevant data set 40 for the query from among data stores 38. Direct analytics system 32 may then prepare a direct analytics output comprising data that directly conforms to the criteria of the query, to provide as a response. Correlated analytics system 22 may include a statistical analysis subsystem 44 and an ontological concept subsystem 50. Correlated analytics system 22 may further perform statistical and ontological analysis on the data in that direct response by direct analytics system 32 and on the complete relevant data set 40 to generate a correlated analytics output.

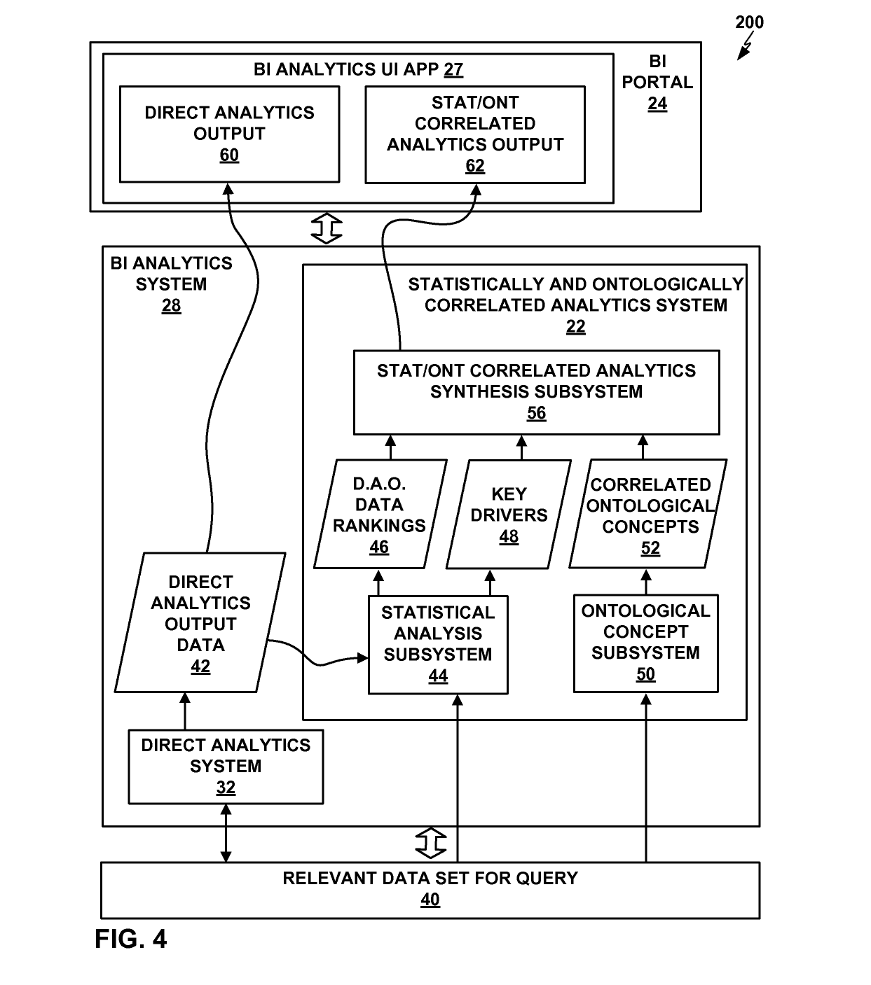

FIG. 4 shows a conceptual block diagram of correlated analytics system 22 performing statistical and ontological analysis on direct analytics output data 42 by direct analytics system 32 and on a complete relevant data set 40 for an analytics query to generate a statistically and ontologically correlated analytics output 62, in one example. Correlated analytics system 22 includes a statistical analysis subsystem 44, an ontological concept subsystem 50, and a correlated analytics synthesis subsystem 56 that synthesizes information from statistical analysis subsystem 44, an ontological concept subsystem 50, in this example. Statistically and ontologically correlated analytics output 62 is statistically and ontologically correlated with a direct analytics output 60 based on direct analytics output data 42, such that it may provide particularly relevant information in the context of the original query outside of the direct, literal response to the query.

Direct analytics system 32, after initially searching for and defining the set of data 40 relevant to the query, may select particular data from among relevant data set 40 that directly responds to the query, and output this data as direct analytics output data 42 to BI analytics UI application 27 for presentation as direct analytics output 60. Correlated analytics system 22 may also input the direct analytics output data 42 to statistical analysis subsystem 44. Correlated analytics system 22 may also input the relevant data set 40 to both statistical analysis subsystem 44 and ontological concept subsystem 50.

Ontological concept subsystem 50 of correlated analytics system 22 may perform an ontological analysis on data items in relevant data set 40 defined for the initial BI analytics query to determine one or more correlations of the data items in relevant data set 40 with ontological concepts included in ontological concept subsystem 50, and output the correlated ontological concepts 52 determined from its analysis. For example, ontological concept subsystem 50 may include ontological concepts organized in generalized conceptual hierarchies such as a geographical hierarchy, a temporal hierarchy, and a business hierarchy. The geographical hierarchy may include concepts of continents, regions, countries, sub-national divisions such as states or provinces, counties, metropolitan areas, and cities, in a hierarchical structure that corresponds to how those geographical entities relate to each other. The temporal hierarchy may include concepts of years, quarters, months, weeks, and days, in a hierarchical structure that corresponds to how those geographical entities relate to each other. The business hierarchy may include business concepts such as companies, divisions, product categories, product lines, and individual products, as well as sales, gross revenues, gross costs, net profits and losses, net costs, and how those concepts relate to each hierarchical level from individual products to a business as a whole.

Ontological concept subsystem 50 may detect data in relevant data set 40 that maps to or can be identified with one of its conceptual hierarchies. For example, ontological concept subsystem 50 may detect, in relevant data set 40, data for sales of products within selected product lines, product categories, divisions, or companies in different geographical regions over different periods of time, potentially also with data on revenues, costs, and profits or losses associated with those sales. Ontological concept subsystem 50 may perform semantic analysis on the data in the relevant data set to detect data that may be correlated to ontological concepts that may be expressed in any of a wide variety of ways. Ontological concept subsystem 50 may identify and output the correlated ontological concepts 52 along with their correlations or mappings to the corresponding data from relevant data set 40.

Statistical analysis subsystem 44 may perform a statistical analysis on direct analytics output data 42 to rank data items in direct analytics output data 42 in an order of influence on direct analytics output 60, and output the direct analytics output rankings 46. Statistical analysis subsystem 44 may also perform a statistical analysis on the data items in relevant data set 40 relative to the data items in direct analytics output data 42 to determine one or more of the data items in relevant data set 40 that influence the respective data items in direct analytics output data 42. Statistical analysis subsystem 44 may thereby generate a list of key drivers 48 from among the data items in direct analytics output data 42, where the key drivers 48 are the data items in relevant data set 40 that particularly influence, or are correlated with, the respective data items in direct analytics output data 42. Statistical analysis subsystem 44 may rank the list of key drivers 48 such that the list of key drivers 48 has a ranking in an order of the influence of the key drivers 48 on the data items in direct analytics output data 42. For example, statistical analysis subsystem 44 may apply techniques such as linear regression analysis, principal component analysis, and/or driver analysis or key driver analysis to determine or identify the key drivers among the data items in relevant data set 40 and to rank the key drivers in a ranked order of influence of the key drivers 48 on the data items in direct analytics output data 42.

Correlated analytics system 22 may also include a statistical and ontological correlated analytics synthesis subsystem 56 (“correlated analytics synthesis subsystem 56”). Correlated analytics synthesis subsystem 56 may receive the direct analytics output data rankings 46 and the ranked list of key drivers 48 from statistical analysis subsystem 44, and the correlated ontological concepts 52 from ontological concept subsystem 50, and synthesize the information it receives into a finalized statistically and ontologically correlated analytics output 62.

For example, correlated analytics synthesis subsystem 56 may compare the key drivers 48 with direct analytics output data 42 to determine if there are any of key drivers 48 that are already present in direct analytics output data 42. If so, correlated analytics synthesis subsystem 56 may remove, from the list of key drivers, any key drivers that are already present in the direct analytics output data 42. Correlated analytics synthesis subsystem 56 may also revise the ranking of the list of key drivers 48 based at least in part on the correlations of the key drivers 48 from among the data items in the relevant data set 40 with the ontological concepts 52. Revising the ranking of the list of key drivers based at least in part on the correlations of the key drivers with the ontological concepts may include ranking key drivers that have correlated ontological concepts higher than key drivers that do not have correlated ontological concepts, or removing key drivers that don't have correlated ontological concepts from the list of key drivers.

Revising the ranking of the list of key drivers based at least in part on the correlations of the key drivers with the ontological concepts may also include ranking key drivers more highly if they are correlated to hierarchical ontological concepts as opposed to non-hierarchical ontological concepts. Revising the ranking of the list of key drivers based at least in part on the correlations of the key drivers with the ontological concepts may also include ranking the key drivers based on rarity of correlated ontological concepts. For example, if only one of the key drivers relates to an ontological concept within a geographical hierarchy, while several of the key drivers relate to business ontological concepts, correlated analytics synthesis subsystem 56 may rank the single data item correlated to the geographical concept more highly, to promote the possibility that it may cast a unique perspective on the most relevant correlated data. Revising the ranking of the list of key drivers based at least in part on the correlations of the key drivers with the ontological concepts may further include ranking the key drivers based on various combinations of both the influence of the key drivers on the data items in direct analytics output data 42 and the correlations of the key drivers with the ontological concepts, including taking into account commonalities between the influence of the key drivers on the data items in direct analytics output data 42 and the correlations of the key drivers with the ontological concepts.

Correlated analytics synthesis subsystem 56 may also select one or more data visualization graphics (“data visualizations”) with which to generate or express a synthesized or finalized correlated analytics output. A data visualization may include a pie chart, a bar chart, a bubble chart, a graph, or any other data visualization or graphic expression of data. Correlated analytics system 22 may then generate a correlated analytics output 62 that includes information on the one or more of the key drivers 48 based on the ranking of the list of key drivers, as the ranking has been ordered based at least in part on the direct analytics output data rankings 46 and the correlated ontological concepts 52. Correlated analytics system 22 outputs the correlated analytics output 62 to BI portal 24 and to BI analytics UI application 27, for BI analytics UI application 27 to display.

Statistical analysis subsystem 44, ontological concept subsystem 50, and correlated analytics synthesis subsystem 56 may each be implemented as portions of executable software code. Each of statistical analysis subsystem 44, ontological concept subsystem 50, and correlated analytics synthesis subsystem 56 may be implemented as separate software applications, separate libraries of software applications, or portions or modules of executable software code within a single software application, in some examples. Statistical analysis subsystem 44, ontological concept subsystem 50, and correlated analytics synthesis subsystem 56 may each be implemented on a single real or virtual server or other computing device, or across multiple real and/or virtual servers or other computing devices, either co-located in a single office, data center, or other facility, or distributed across multiple offices, data centers, and potentially widely geographically distributed, as further described below.

In one example, user 12A using BI analytics UI application 27 may compose an analytics query 31 to inquire, “how do U.S. market survey scores compare by year and product line?” BI analytics UI application 27 may enable user 12A to compose this analytics query in natural language rather than in a structured query language, such that direct analytics system 32 may interpret the natural language query in terms of four data items, “U.S.,” “market survey scores,” “year,” and “product line.” In some examples, user 12A may also compose query 31 using a structured query language. Direct analytics system 32 may search data stores 38 and define relevant data set 40 for the query 31. Direct analytics system 32 may generate direct analytics output data 42 that is directly responsive to query 31, and that direct analytics system 32 outputs in direct analytics output 60, potentially in the form of a chart, graph, or other data visualization.

Ontological concept subsystem 50 may also perform an ontological analysis on the data items in relevant data set 40 and determine correlations of categories of the data items relevant data set 40 with ontological concepts, such as in the following examples (in which ontological concepts are named with a letter “c” prefix):

| Relevant Data Category | | Ontological Concept |
|---|---|---|
| Product | → | cIdentifier |
| Product Line | → | cNominal |
| Year | → | cTemporal |
| Country | → | cGeographical |
| Lead Office | → | cIdentifier |
| Market Survey | → | cMetric |
| Domestic Gross | → | cRevenue |
| Foreign Gross | → | cRevenue |
| Worldwide Gross | → | cRevenue |
| Budget | → | cRevenue |
| Profit Margin | → | cRevenue |
| Net Profit | → | cRevenue |
| Sales Staff | → | cHumanResources |
| Company Division | → | cIdentifier |

In this example, the data categories “year” and “country” from relevant data 40 have correlated ontological concepts within the temporal and geographical ontological hierarchies, respectively, while the other relevant data categories are correlated with business ontological concepts, including business concepts of identifiers, nominal, metrics, revenue, and human resources. The “product,” “product line,” “lead office,” and “company division” categories of the relevant data items 40 may correlate to a business ontology hierarchy for an interrelated product organization and company organization.

Statistical analysis subsystem 44 may also perform a first statistical analysis on direct analytics output data items 42 to rank the four direct analytics output data items in this example, “U.S.,” “market survey score,” “year,” and “product line,” in an order of influence on the direct BI analytics output 60. This may include generalizing the particular data item “U.S.” into the applicable data item category “country.” Statistical analysis subsystem 44 may rank direct analytics output data 42 in the order of influence of each of the data items in direct analytics output data 42 on direct analytics output 60 in the sense of which are the most influential data on the combined output according to one or more statistical analysis techniques such as principal component analysis, regression analysis, factor analysis, or key driver analysis, for example. Statistical analysis subsystem 44 may, for example, determine the four direct output data items in the order of influence may be as follows:

Direct Output Data Items Ranked by Influence
1. Product Line
2. Country
3. Year
4. Market survey score

Statistical analysis subsystem 44 may further perform a second statistical analysis on the data items in the relevant data set 40 relative to the direct analytics output data items 42 to determine one or more of the data items in the relevant data set 40 that influence the respective direct analytics output data items 42. Statistical analysis subsystem 44 may thereby generate a list of key drivers 48 from among the data items in the relevant data set 40 such that the list of key drivers 48 has a ranking in an order of their influence on the direct analytics output data items 42. For example, statistical analysis subsystem 44 may generate, with respect to query 31 as discussed above, a list of key drivers related to the direct output data 42, in a ranked order of influence of the key drivers on the direct output data 42, as follows:

| Direct Output Data | | Key Driver |
|---|---|---|
| Product Line | → | Profit Margin |
| Product Line | → | Revenue |
| Country | → | Revenue |
| Country | → | Sales Staff |
| Product Line | → | Net Profits |
| Country | → | Net Profits |
| Year | → | Profit Margin |
| Market Survey | → | Product |
| Market Survey | → | Product Line |
| Product Line | → | Net Profits |
| Year | → | Net Profits |
| Market Survey | → | Lead Office |
| Year | → | Budget |
| Market Survey | → | Market Research Firm |

Statistical analysis subsystem 44 may also determine statistical information about one or more of the key drivers, such as minimum, maximum, and average values of the key drivers, including as correlated with direct output data or other key drivers. For example, statistical analysis subsystem 44 may determine minimum, maximum, and average country revenue per year, or profit margin per product line, or profits by country, and may rank such data item correlations from highest to lowest. Subsequently generating the correlated analytics output may then include information such as the minimum, the maximum, the average value, the top subset, or the lowest subset of the one or more of the key drivers and how they correlate to other data items, such as years with highest or lowest revenue, or product lines with highest or lowest profit margins in a certain country, either of which may be globally or in a certain country, for example.

Correlated analytics synthesis subsystem 56 may receive the correlated ontological concepts 52, the direct analytics output data rankings 46, and the ranked list of key drivers 48 as described above. Correlated analytics synthesis subsystem 56 may then screen the key drivers to remove any key drivers that are already present in the direct analytics output data items 42. For instance, the example list of key drivers given above includes “product line,” found as a key driver of the “market survey” data category in the direct analytics output 42, while the “product line” data item category is already included in direct analytics output 42. Correlated analytics synthesis subsystem 56 may thus remove the “product line” data item category from the key drivers.

Correlated analytics synthesis subsystem 56 may also revise the ranking of the list of key drivers based at least in part on the correlations of the key drivers with the ontological concepts. For example, correlated analytics synthesis subsystem 56 may rank key drivers that it finds lack a correlated ontological concept lower than those key drivers that do have correlated ontological concepts, or correlated analytics synthesis subsystem 56 may simply remove key drivers that lack a correlated ontological concept. In one example referring to the list of key drivers given above, correlated analytics synthesis subsystem 56 may determine that the key driver “market research firm” that statistically correlates with or influences the relevant data item category “market survey” does not have a correlated ontological concept from ontological concept subsystem 50. Correlated analytics synthesis subsystem 56 may, for example, remove the “market research firm” key driver from consideration for the correlated analytics output.

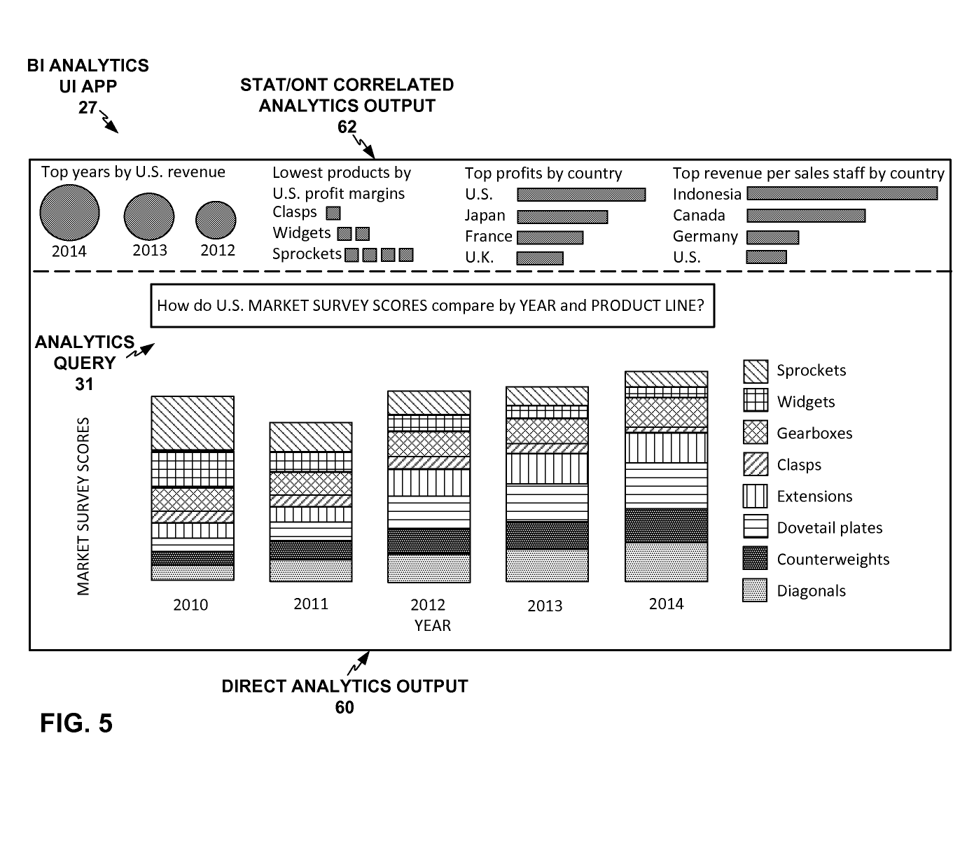

As another example, correlated analytics synthesis subsystem 56 may also revise the ranking of the list of key drivers based at least in part on the correlations of the key drivers with the ontological concepts by determining that since the “country” relevant data category is the only representative relevant data category correlated to the important “geographical” hierarchy of ontological concepts, and may thereby convey special and rare perspectives, and since “country” is ranked as the second highest of the direct output data items ranked by influence, correlated analytics synthesis subsystem 56 will revise the ranking of key drivers to promote the key drivers of the “country” direct output data category. Since “revenue” and “net profits” are key drivers of the “country” direct output data category as well as additional direct output data categories, these key drivers may end up at or near the top of the revised, finalized ranking of key drivers as determined by correlated analytics system 22. Additionally, the “sales staff” key driver is correlated only with the “country” direct output data category, but may also end up with a relatively high ranking in the finalized ranking of key drivers as determined by correlated analytics system 22. These results are reflected in the example correlated analytics output 62 as shown in FIG. 5.

FIG. 5 shows an example screenshot of BI analytics UI application 27 with a direct analytics output 60 as generated by direct analytics system 32 and a statistically and ontologically correlated analytics output 62 as generated by correlated analytics system 22, in response to analytics query 31, in one example. Direct analytics output 60 is generated by direct analytics system 32 in the form of a color-coded stacked bar chart showing market survey scores by year, for the most recent five years, for each of eight product lines that enterprise 4 may carry in this example. Statistically and ontologically correlated analytics output 62 as generated by correlated analytics system 22 shows a selection of additional data items and the influences or correlations between the data items selected by correlated analytics system 22 from among the complete relevant data set with respect to the original query for having some of the highest-ranked combined statistical and ontological correlations of interest with the direct analytics outputs. Statistically and ontologically correlated analytics output 62 as generated by correlated analytics system 22 may include some of the most “interesting” additional information from the complete data set relevant to the original query, that the user may be interested in exploring, and that ideally may provide insights and surprises adjacent to the user's intent as manifested in the query, and ideally may provide answers to questions the user had not yet explicitly formulated.

Statistically and ontologically correlated analytics output 62 (“correlated analytics output 62”) generated by correlated analytics system 22 includes data influences and correlations that reflect the processes and rankings as described above, including data influences and correlations among revenues, years, profits, and countries, and related data categories. In particular, in this example, correlated analytics output 62 includes (from left to right as depicted in FIG. 5) a bubble chart of top years by U.S. revenue, a box chart of the lowest products by U.S. profit margins, a bar chart of the top profits by country, and a bar chart of the top revenue per sales staff by country.

The inclusion of the bar chart of the top revenue per sales staff by country, for example, reflects the determination by correlated analytics system 22 that the “country” data item in the direct analytics output is relatively highly ranked in influence among the data items in the direct analytics output (ranked second of four), and is ontologically valuable and is promoted in the rankings due to its status as the sole representative of the ontologically valuable geographical hierarchy of concepts indicated by the ontological concept subsystem; that “revenue” is a top key driver of both of the two top-ranked data items in the direct analytics output, both product line and country; and that “sales staff” is determined to be among the top key drivers of the “country” data item category. Correlated analytics system 22 has therefore ranked the data correlations between country, revenue, and sales staff highly among its finalized ranked list of key drivers in this example, based on the ranking of the list of key drivers determined and revised by correlated analytics system 22, such that correlated analytics system 22 included a graphic visualization of the data correlations between country and sales staff as part of the initial or top-level correlated analytics output 62. Correlated analytics system 22 may also generate more correlated data visualizations or output elements beyond those shown in an initial view, which a user may access such as by scrolling or paging through to additional views.

In this example, the user may have begun to explore enterprise data by formulating a query about U.S. market survey scores compared by year and product line, but this initial query may reflect a more general intent to explore certain aspects of business data, such as searching for analytics on how to improve sales performance, and correlated analytics system 22 may effectively combine the initial query with statistical analysis and ontological analysis to present additional analytics data in correlated analytics output 62 that may be particularly relevant to the user's more general intent. The user may find the correlated analytics output 62 a valuable source of insight to explore new aspects of the data, even though the user may not have thought to formulate explicit queries that would have directly generated any of the data analytics correlations or information in correlated analytics output 62. In the particular example of the bar chart for top revenue per sales staff by country, the user may be surprised to learn that especially Indonesia and also Canada are far outperforming other national markets in terms of revenues per sales staff, which may indicate some combination of untapped sales potential and unusually talented sales staff in those countries, either of which may be interesting for the user with the general intent, as reflected in the original query, of exploring how to increase sales performance.

Correlated analytics output 62 may be enabled with BI drill-down functionality as in other UI elements of BI portal 24, and such unexpected insights in correlated analytics output 62 generated by correlated analytics system 22 may serve as jumping-off points for the user to drill down in the bar chart of top revenue per sales staff by country, for example, to explore further analytics and other BI resources with more detailed data. Correlated analytics system 22 may generate correlated analytics output 62 in formats that enable, facilitate, or otherwise provide drill-down functionality in correlated analytics output 62 to enable access to additional data sources related to the information in the correlated analytics output, including in relevant data set 40 or in data sources 38 at large. BI portal 24 and/or BI analytics UI application 27 may also enable, facilitate, or otherwise provide such BI drill-down functionality.

Correlated analytics system 22 may also respond to user inputs to access such drill-down functionality or otherwise interact with correlated analytics output 62 by receiving the new user interactions as new queries or inputs or additions to the existing query 31 or composing a new query based on or translating the new user inputs or interactions, and repeating any or all of the processes described above to generate additional new correlated analytics outputs, or otherwise generating a subsequent output that includes additional information related to the key drivers and responsive to the new input. For example, the user may click on, touch, or otherwise select the “Indonesia” bar in the bar chart for top revenue per sales staff by country. BI analytics system 28 may respond by generating more detailed analytics data on sales revenues in Indonesia (e.g., broken down by year and sales account managers) in the main view of BI analytics UI application 27 in place of direct analytics output 60. Correlated analytics system 22 may also respond to this input, by performing new ontological and statistical analyses on “revenue per sales staff in Indonesia” as a new direct analytics query, in accordance with the processes described above, and generate a new correlated analytics output in response to this new query.

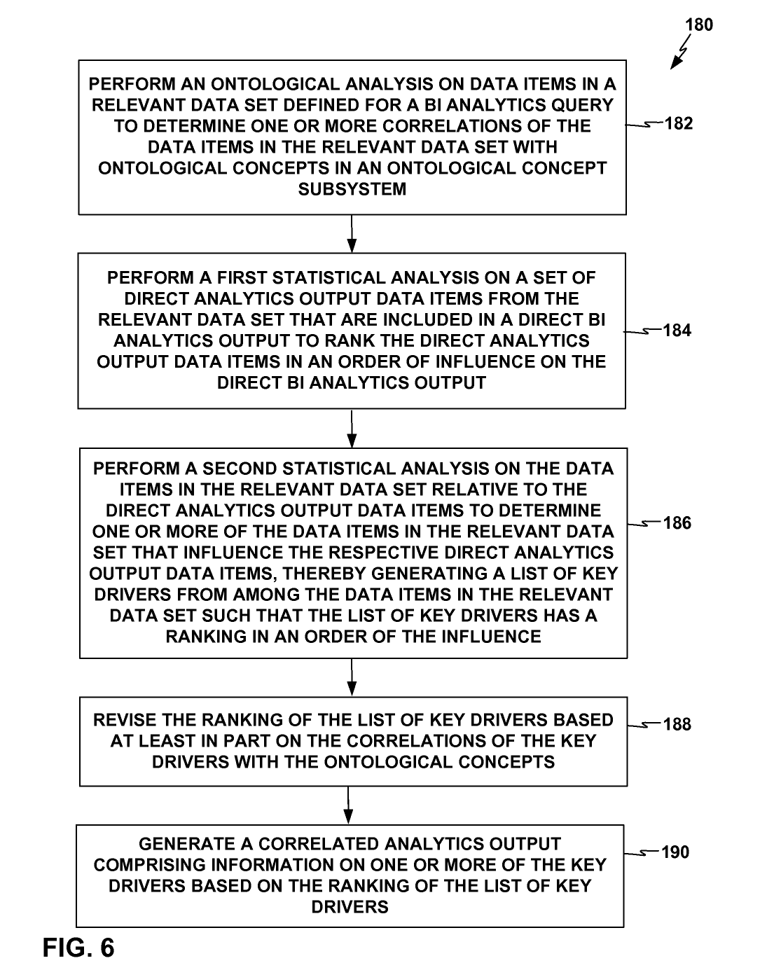

FIG. 6 shows a flowchart for a statistically and ontologically correlated analytics process 180 that correlated analytics system 22, executing on one or more computing devices (e.g., application servers 14B, other servers, computers, processors, etc.), may perform, in one example. Correlated analytics system 22 may perform an ontological analysis on data items in a relevant data set defined for a BI analytics query to determine one or more correlations of the data items in the relevant data set with ontological concepts in an ontological concept subsystem (e.g., ontological concept subsystem 50 may determine correlations of data items in relevant data set 40 with ontological concepts, and outputs correlated ontological concepts 52) (182). Correlated analytics system 22 may perform a first statistical analysis on a set of direct analytics output data items from the relevant data set that are included in a direct BI analytics output to rank the direct analytics output data items in an order of influence on the direct BI analytics output (e.g., statistical analysis subsystem 44 may perform a statistical analysis on direct analytics output data 42 to rank direct analytics output data 42 in order of influence on direct analytics output 60, and outputs direct analytics output data rankings 46) (184).

Correlated analytics system 22 may perform a second statistical analysis on the data items in the relevant data set relative to the direct analytics output data items to determine one or more of the data items in the relevant data set that influence the respective direct analytics output data items, thereby generating a list of key drivers from among the data items in the relevant data set such that the list of key drivers has a ranking in an order of the influence (e.g., statistical analysis subsystem 44 may perform a statistical analysis on relevant data set 40 and generate a ranked list of key drivers 48 that is ranked in order of influence of the key drivers from relevant data set 40 on direct analytics output data 42) (186). Correlated analytics system 22 may revise the ranking of the list of key drivers based at least in part on the correlations of the key drivers with the ontological concepts (e.g., correlated analytics synthesis subsystem 56 may revise the ranking of the list of key drivers 48 based at least in part on the correlations of the key drivers 48 with the correlated ontological concepts 52) (188). Correlated analytics system 22 may generate a correlated analytics output comprising information on one or more of the key drivers based on the ranking of the list of key drivers (e.g., correlated analytics synthesis subsystem 56 may generate correlated analytics output 62 based on a synthesis of information from direct analytics output data rankings 46, key drivers 48, and correlated ontological concepts 52, including information on key drivers 48 based on the ranking of the list of key drivers 48 based at least in part on the correlations of the key drivers 48 with the correlated ontological concepts 52) (190).

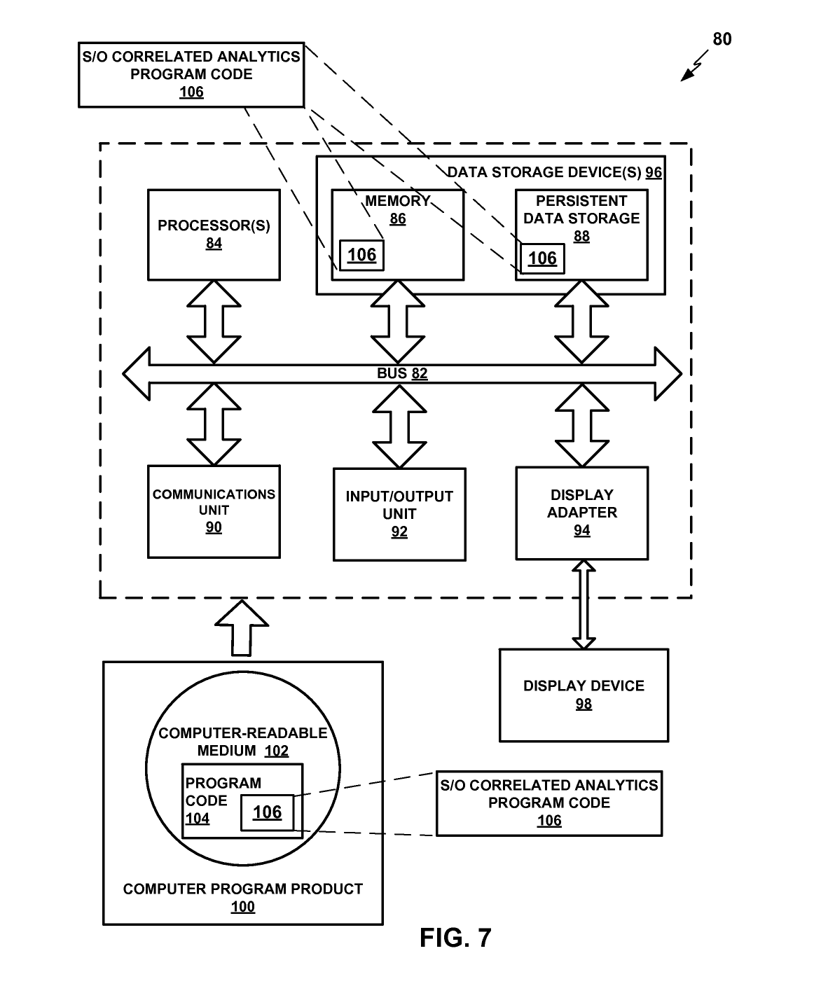

FIG. 7 is a block diagram of a computing device 80 that may be used to execute statistically and ontologically correlated analytics program code 106 (“correlated analytics program code 106”) and to implement a correlated analytics system 22, in one example. Correlated analytics program code 106 may perform, implement, or embody any or all of the functions, techniques, or processes ascribed above to correlated analytics system 22 and/or components thereof. Computing device 80 may be a server such as one of web servers 14A or application servers 14B as depicted in FIG. 2. Computing device 80 may also be any server for providing an enterprise business intelligence application in various examples, including a virtual server that may be run from or incorporate any number of computing devices. A computing device may operate as all or part of a real or virtual server, and may be or incorporate a workstation, server, mainframe computer, notebook or laptop computer, desktop computer, tablet, smartphone, feature phone, or other programmable data processing apparatus of any kind Other implementations of a computing device 80 may include a computer having capabilities or formats other than or beyond those described herein.

In the illustrative example of FIG. 7, computing device 80 includes bus 82, which provides communications between processor unit 84, memory 86, persistent data storage 88, communications unit 90, and input/output (I/O) unit 92. Bus 82 may include a dedicated system bus, a general system bus, multiple buses arranged in hierarchical form, any other type of bus, bus network, switch fabric, or other interconnection technology. Bus 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through bus 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. These computer-executable instructions that may be loaded from persistent data storage 88 into memory 86 to be read and executed by processor unit 84 or other processors may include correlated analytics program code 106 to implement correlated analytics system 22 as described above. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Data storage 96 may include any of various forms of volatile memory that may require being periodically electrically refreshed to maintain data in memory, while those skilled in the art will recognize that this also constitutes an example of a physical, tangible, non-transitory computer-readable data storage device. Executable instructions may be stored on a non-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for a correlated analytics system 22, as described in greater detail above. This program code may be stored on memory 86, persistent data storage 88, or elsewhere in computing device 80. This program code may also take the form of program code 104 stored on computer-readable medium 102 comprised in computer program product 100, and may be transferred or communicated, through any of a variety of local or remote means, from computer program product 100 to computing device 80 to be enabled to be executed by processor unit 84, as further explained below. Program code 104 may include correlated analytics program code 106 to implement correlated analytics system 22 as described above.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or data storage 96. Input/output unit 92 may also include appropriate device drivers for any type of external device, or such device drivers may reside elsewhere on computing device 80 as appropriate.

Computing device 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of storage medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing or configuring processor unit 84 to generate physical outputs that correspond to the computer-executable instructions, in a way that causes computing device 80 to physically assume new capabilities that it did not have until its physical state was changed by loading the executable instructions comprised in program code 104.

In some illustrative examples, program code 104 may be downloaded over a network to data storage 96 from another device or computer system for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-10. (canceled)

11. A computer program product for business intelligence (BI) analytics, the computer program product comprising a computer-readable storage medium having program code embodied therewith, the program code executable by a computing device to:
perform an ontological analysis on data items in a relevant data set defined for a BI analytics query to determine one or more correlations of the data items in the relevant data set with ontological concepts in an ontological concept subsystem;
perform a first statistical analysis on a set of direct analytics output data items from the relevant data set that are included in a direct BI analytics output to rank the direct analytics output data items in an order of influence on the direct BI analytics output;
perform a second statistical analysis on the data items in the relevant data set relative to the direct analytics output data items to determine one or more of the data items in the relevant data set that influence the respective direct analytics output data items, thereby generating a list of key drivers from among the data items in the relevant data set such that the list of key drivers has a ranking in an order of the influence;
revise the ranking of the list of key drivers based at least in part on the correlations of the key drivers with the ontological concepts; and
generate a correlated analytics output comprising information on one or more of the key drivers based on the ranking of the list of key drivers.

12. The computer program product of claim 11, wherein the program code is further executable by the computing device to remove, from the list of key drivers, key drivers that are already present in the direct analytics output data items.

13. The computer program product of claim 11, wherein the program code executable by the computing device to generate the correlated analytics output comprising the information on the one or more of the key drivers based on the ranking of the list of key drivers further comprises program code executable by the computing device to generate a correlated analytics output comprising information on how the key drivers influence the direct analytics output data items.

14. The computer program product of claim 11, wherein the program code executable by the computing device to generate the correlated analytics output comprising the information on the one or more of the key drivers comprises program code executable by the computing device to generate the correlated analytics output comprising correlations between one or more of the key drivers and one or more of the direct analytics output data items based on the ranking of the list of key drivers.

15. The computer program product of claim 11, wherein the program code executable by the computing device to revise the ranking of the list of key drivers based at least in part on the correlations of the key drivers with the ontological concepts further comprises program code executable by the computing device to rank key drivers that have a correlation with one of the ontological concepts higher than key drivers that do not have a correlation with one of the ontological concepts.

16. A computer system for business intelligence (BI) analytics, the computer system comprising:
one or more processors, one or more computer-readable memories, and one or more computer-readable, tangible storage devices;
program instructions, stored on at least one of the one or more storage devices for execution by at least one of the one or more processors via at least one of the one or more memories, to perform an ontological analysis on data items in a relevant data set defined for a BI analytics query to determine one or more correlations of the data items in the relevant data set with ontological concepts in an ontological concept subsystem;
program instructions, stored on at least one of the one or more storage devices for execution by at least one of the one or more processors via at least one of the one or more memories, to perform a first statistical analysis on a set of direct analytics output data items from the relevant data set that are included in a direct BI analytics output to rank the direct analytics output data items in an order of influence on the direct BI analytics output;
program instructions, stored on at least one of the one or more storage devices for execution by at least one of the one or more processors via at least one of the one or more memories, to perform a second statistical analysis on the data items in the relevant data set relative to the direct analytics output data items to determine one or more of the data items in the relevant data set that influence the respective direct analytics output data items, thereby generating a list of key drivers from among the data items in the relevant data set such that the list of key drivers has a ranking in an order of the influence;
program instructions, stored on at least one of the one or more storage devices for execution by at least one of the one or more processors via at least one of the one or more memories, to revise the ranking of the list of key drivers based at least in part on the correlations of the key drivers with the ontological concepts; and
program instructions, stored on at least one of the one or more storage devices for execution by at least one of the one or more processors via at least one of the one or more memories, to generate a correlated analytics output comprising information on one or more of the key drivers based on the ranking of the list of key drivers.

17. The computer system of claim 16, further comprising program instructions to remove, from the list of key drivers, key drivers that are already present in the direct analytics output data items.

18. The computer system of claim 16, wherein the program instructions to generate the correlated analytics output comprising the information on the one or more of the key drivers based on the ranking of the list of key drivers further comprise program instructions to generate a correlated analytics output comprising information on how the key drivers influence the direct analytics output data items.

19. The computer system of claim 16, wherein the program instructions to generate the correlated analytics output comprising the information on the one or more of the key drivers comprise program instructions to generate the correlated analytics output comprising correlations between one or more of the key drivers and one or more of the direct analytics output data items based on the ranking of the list of key drivers.

20. The computer system of claim 16, wherein the program instructions to revise the ranking of the list of key drivers based at least in part on the correlations of the key drivers with the ontological concepts further comprise program instructions to rank key drivers that have a correlation with one of the ontological concepts higher than key drivers that do not have a correlation with one of the ontological concepts.
